(19) United States
(12) Patent Application Publication
(10) Pub. No.: US 2017/0040872 A1
(43) Pub. Date: Feb. 9, 2017

(54) ELECTRIC MACHINE COMPRISING A COOLED ROTOR

(71) Applicant: ZF Friedrichshafen AG, Friedrichshafen (DE)

(72) Inventors: Matthias Nitsch, Ulm (DE); Andreas Hölscher, Uhldingen-Mühlhofen (DE)

(73) Assignee: ZF Friedrichshafen AG, Friedrichshafen (DE)

(21) Appl. No.: 15/304,724

(22) PCT Filed: Mar. 17, 2015
(86) PCT No.: PCT/EP15/55476

§ 371 Date: Oct. 17, 2016

(30) Foreign Application Priority Data
Apr. 17, 2014 (DE) 10 2014 207 470.3

(51) Int. Cl. H02K 9/19; H02K 7/116; H02K 1/27; H02K 7/08; H02K 1/32; H02K 1/12

(52) U.S. Cl. CPC H02K 9/19; H02K 1/32; H02K 1/12; H02K 1/2706; H02K 7/08; H02K 7/116

(57) ABSTRACT

The invention relates to an electric machine having a stator and a rotor, wherein the stator has windings having at least one winding head at the end, and wherein the rotor has at least one at least partially helical coolant channel, which is open axially toward this winding head, such that coolant is conveyed out of the coolant channel toward the winding head when the rotor rotates. It is provided thereby that the rotor and the at least one coolant channel are designed such that when the rotor rotates, the coolant is thrown axially out of the coolant channel and the rotor beyond the winding head.

The invention also relates to a vehicle drive train having such an electric machine as a traction drive.

The invention relates to an electric machine having a stator and a rotor, wherein the stator has windings with at least one winding head at the end. The rotor has at least one coolant channel that is at least partially helical, which is open axially toward this winding head, such that coolant is conveyed when the rotor is rotating, out of the coolant channel and the rotor, toward the winding head. The invention also relates to a vehicle drive train having such an electric machine as a traction drive.

An electric machine of this type is known from DE 10 2011 079 165 A1. Another electric machine having a liquid-cooled rotor is known from DE 11 2010 005 824 T5, wherein there is no helical coolant channel provided in the rotor. It is disadvantageous with the known electric machines that coolant from the coolant channel ends up on the stator or the winding head of the stator, such that a slight amount of coolant is able to enter an air gap between the rotor and the stator. The coolant ending up in the air gap causes shearing forces between the rotor and the stator, which generate a braking torque on the rotor, thus reducing the efficiency of the electric machine.

The object of the invention is therefore to create an electric machine in which less, or no, coolant from the rotor can end up in the air gap between the rotor and the stator.

The object is achieved with an electric machine having the features of claim 1. Preferred embodiments thereof can be derived from the dependent Claims.

Accordingly, an electric machine having a stator and a rotor is proposed, wherein the stator has electrical windings with at least one winding head at the end, and wherein the rotor has at least one at least partially helical coolant channel. This coolant channel is open at least axially toward the winding head, such that coolant is conveyed from the coolant channel and the rotor toward this winding head when the rotor rotates.

It is provided thereby that the rotor and the at least one coolant channel are designed such that when the rotor rotates, the coolant is thrown axially out of the coolant channel and the rotor, beyond this winding head.

The coolant channel is designed such that, in particular, this centrifugal effect is caused at typical operating rotational rates of the electric machine, or at approximately the nominal rotational rate of the electric machine. As a result of the centrifugal effect of the coolant channel, the coolant is thus no longer thrown against the winding head, resulting in less, or no, coolant ending up in the air gap between the rotor and the stator. Instead, the coolant is thrown beyond the winding head. The coolant channel can be designed such that it runs in its entirety, axially along the rotor, in a helical path, or it may be designed such that it is only runs in a helical path in sections. The coolant channel may be closed radially over its length, either entirely or in sections. Or the coolant channel can be open radially over its entire length. The coolant channel can, in particular, be helical about an axis of rotation for the rotor. In particular, an axial extension of the rotor is smaller than an axial extension of the stator. Accordingly, the winding head, or the winding heads, respectively, of the stator extend axially beyond the rotor.

The invention is suitable in particular for use in quickly rotating electric machines. The slope of the coolant channel is such (in terms of its direction) that the coolant is conveyed through the coolant channel toward the axial opening of the coolant channel when the electric machine rotates in the normal direction during operation.

In a preferred further development, a slope of the helical portion of the coolant channel increases axially toward the winding head. Thus, the slope of the coolant channel increases toward an end surface of the winding head. The coolant located in the coolant channel is accelerated toward the winding head, or the frontal end of the rotor, and is thus thrown beyond the winding head after leaving the coolant channel in a particularly effective manner. The slope can increase linearly or exponentially, by way of example.

In a further development, the rotor has an inner part, on the radial inner wall of which the coolant channel is disposed. The coolant channel is formed thereby by a groove in the inner part, opening radially inward. The inner part can be, in particular, a pot-shaped inner part. It can be made, in particular, of sheet metal, and/or it can be a deep drawn component, in particular. As a result of these measures, the coolant channel can be incorporated in the rotor in a particularly simple and economical manner. The rotor preferably has a laminated core, which is disposed such that it is secured radially to the inner part. As a result, the rotor can be manufactured in a particularly economical manner.

The central idea of an inner part, on the inner wall of which the coolant channel is disposed, is that, as a result of the centrifugal force arising when the rotor rotates, the coolant is pushed into the coolant channel. The coolant channel has a certain slope, which conveys the coolant toward an end of the coolant channel located on an axial end surface of the rotor. Heat is discharged from the rotor thereby. By increasing the slope of the coolant channel toward the winding head, or the frontal end of the coolant channel, the axial exiting speed of the coolant from the rotor is increased. As a result, the coolant can be thrown particularly far away from the winding head. By increasing the depth of the coolant channel, the speed of the coolant in the coolant channel can be increased, which likewise results in an increased discharge speed of the coolant from the rotor, and thus an improved centrifugal effect when discharged from the coolant channel, and an increased cooling performance in the rotor. The basis for this is that by increasing the depth of the coolant channel, an increased rotational pressure is exerted on the coolant in the coolant channel, which ultimately results in an increase in the speed of the coolant in the coolant channel.

In a further development, the electric machine has a transmission step, which is provided radially inside the inner part. The electric machine furthermore has an output shaft, at which a rotational torque of the electric machine can be tapped into. The transmission step is designed thereby such that it translates a rotational speed of the rotor into another rotational speed of the output shaft. The transmission step can speed up the rotational speed of the rotor, i.e. such that the rotational speed of the output shaft is faster than the rotational speed of the rotor, or it can slow it down, i.e. such that the rotational speed of the output shaft is slower than the rotational speed of the rotor. As a result, a particularly compact electric machine can be created, which has an integrated transmission step.

It is preferred thereby that the transmission step is designed as a planetary stage. Such a planetary stage is composed, in particular, of a ring gear, one or more planet gears, and a sun gear, which mesh with one another in the known manner. The inner part can be connected to the ring gear, in at least a non-rotational manner, or it can form the ring gear itself. The output shaft can then be connected to the planet carrier or the sun gear of the planetary stage, at least in a non-rotational manner. In particular, the output shaft is non-rotatably connected to the planet carrier of the transmission step. By means of a transmission step designed as a planetary stage, a high transmission ratio can be obtained in a particularly compact design. The coolant preferably also serves as a lubricant thereby. Thus, the coolant serves to cool the rotor and to lubricate the transmission step. The coolant is thus an oil or lubricant, in particular a transmission fluid.

In a further development, the rotor is rotatably supported via the inner part and a first bearing disposed radially inside the inner part. A radial force acting on the rotor is thus supported by the inner part and the first bearing disposed inside the inner part, e.g. on the output shaft of the electric machine. Alternatively or additionally, the rotor can be rotatably supported by the inner part and a second bearing disposed outside the inner part. A radial force that acts on the rotor is thus supported by the inner part and the second bearing disposed radially outside the inner part, preferably on a housing of the electric machine. If both bearings are provided, the rotor can then be rotatably supported on the output shaft as well as a housing of the electric machine. The rotor is preferably supported exclusively by means of the bearing or bearings disposed on the inner part of the rotor.

Preferably the first bearing is designed as a fixed bearing, and thus supports radial and axial forces of the rotor. The second bearing is then designed as a floating bearing, and thus only supports radial forces of the rotor. This has the advantage that a thermal expansion of the rotor does not result in a substantial change in position of the stator in relation to the rotor.

It may be provided that a coolant entry into the coolant channel is located in the region of a first end surface of the rotor, wherein this end surface lies opposite the end surface of the rotor at which the coolant channel is open toward the winding head. Thus, the coolant is conveyed through the coolant channel over approximately the entire axial length of the rotor. As a result, the cooling effect generated by the coolant channel is particularly effective.

The electric machine described herein is particularly suited for driving a vehicle, e.g. a passenger automobile or a truck, i.e. as a traction drive of the vehicle. The invention thus also relates to a vehicle drive train having an electric machine as the traction drive, which is designed in the manner explained above.

The invention shall be explained below based on further examples, from which further preferred embodiments of the invention can be derived. Therein, schematically:

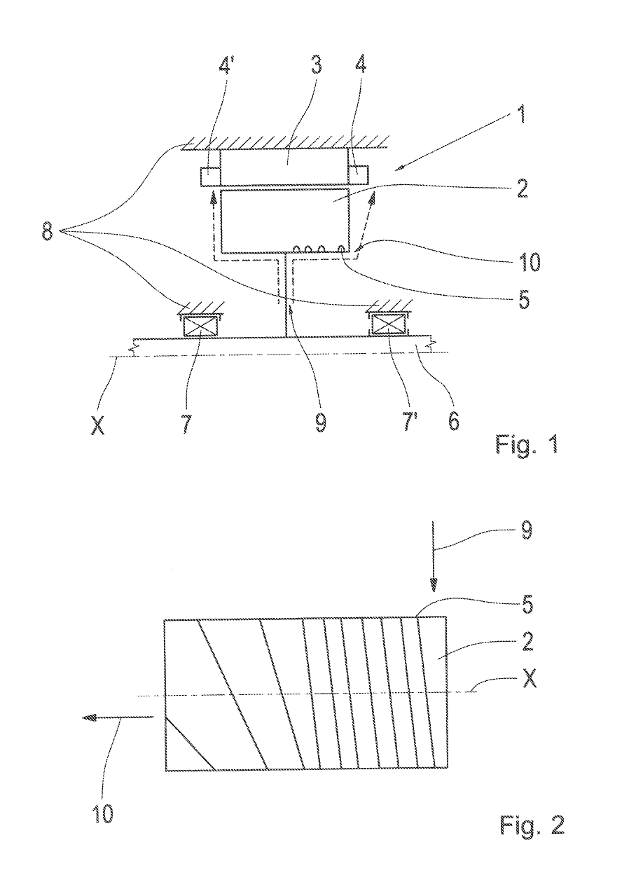

FIG. 1 shows a longitudinal section through an electric machine;

FIG. 2 shows an unrolled profile of a coolant channel of a rotor;

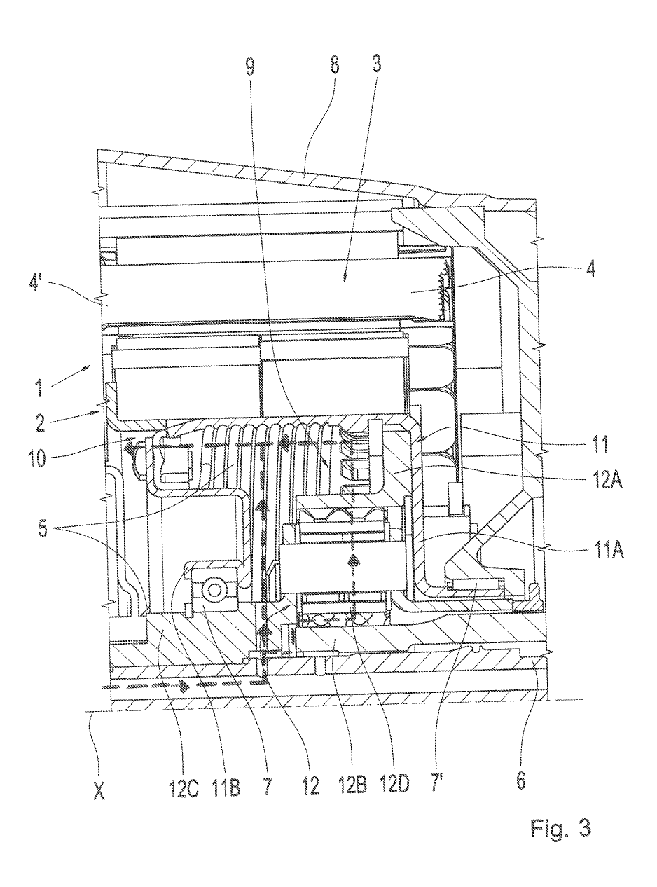

FIG. 3 shows a longitudinal section of an electric machine in a vehicle drive train.

Components or elements that are identical, or at least have the same function, are provided with the same reference symbols in the figures.

FIG. 1 shows a longitudinal section through an electric machine 1. The electric machine 1 has a stator 3 and a rotor 2. The rotor 2 is securely connected to the output shaft 6 of the electric machine 1. The rotor 2 and output shaft 6 are rotatably supported in a housing 8 of the electric machine 1 via bearings 7, 7′. The stator 3 is securely connected to the housing 8. The stator 3 has numerous electrical windings of electrical conductors, e.g. copper wires, and it has a winding head 4, 4′ at each axial end surface. The rotor 2 is disposed radially inside the stator 3, such that the electric machine 1 is thus an internal rotor machine.

The rotor 2 has a liquid cooling system, having at least one coolant channel 5 located in the rotor 2. The liquid cooling system ensures that coolant is conducted radially toward the rotor 2 in the coolant channel 5, starting from the output shaft 6. The coolant flows through the coolant channel 5 along a radial inner surface of the rotor 2, to the axial end surfaces of the rotor 2, thus toward the winding heads 4, 4′ of the stator 3.

As is depicted on the left-hand side of FIG. 1, it may be the case thereby that coolant from the rotor 2 strikes a winding head 4, 4′ of the stator 3. Coolant can rebound from the winding head 4, 4′ thereby, and end up in the air gap between the stator 3 and the rotor 2, where it causes shearing forces between the rotor 2 and the stator 3. As a result, a braking torque is generated between the rotor 2 and the stator 3, and the efficiency of the electric machine 1 is reduced.

It is therefore provided that the coolant channel 5 is at least partially helical in the axial direction. The coolant channel 5 thus forms a helix around a rotational axis X of the rotor 2. The coolant channel 5 is open in an axial direction of one of the winding heads 4, 4′ of the stator, such that coolant is conveyed out of the coolant channel 5 toward this winding head 4, 4′ when the rotor 2 rotates. This occurs in a manner such that coolant is thrown axially beyond this winding head 4, 4′. The coolant channel 5 is designed accordingly for this. This is illustrated symbolically on the right-hand side of FIG. 1. As a result of the centrifugal force occurring when the rotor 2 rotates, the coolant located radially inside the rotor 2 is pushed into the coolant channel 5, such that a rotational pressure is exerted on the coolant in the coolant channel 5. As a result of helical shape and the axial opening of the coolant channel 5, the coolant then obtains an axial directional component when the rotor 2 rotates, and is thrown axially away from the rotor when it exits the coolant channel 5, or the rotor 2, respectively. The slope of the coolant channel 5 is thus such that coolant is conveyed through the coolant channel 5 toward the axial opening of the coolant channel 5 when the electric machine 1 rotates in the normal direction during operation thereof.

It is provided that this axial directional component is sufficient to throw the bulk of the coolant beyond the corresponding winding head 4, 4′, in particular at the typical operational rotational rates of the electric machine 1. As a result, no, or at least significantly less, coolant ends up in the air gap between the rotor 2 and the stator 3. It should be noted here that the rotor 2 has a shorter axial extension than the stator 3. Accordingly, the winding heads 4, 4′ of the stator 3 extend beyond the rotor 2, extending axially away from the stator 3.

As is depicted in FIG. 1, the coolant channel 5 can be designed for this purpose as a groove in a radial inner wall of the rotor 2. The groove is open, e.g. over its entire length, radially inward, and opens out axially into an end surface of the rotor 2. Alternatively, it can be closed radially toward the inside, at least in sections. The coolant channel 5 can run thereby in a single track or in multiple tracks along the radial inner wall of the rotor 2. A slope of the coolant channel 5 increases axially toward the winding heads 4, 4′, or the respective end surface of the rotor 2. Thus, the slope increases as it approaches the end surface of the rotor 2, from which the coolant exits the coolant channel 5 (coolant exit 10).

In accordance with FIG. 1, a coolant entry 9 may be provided in an axially central region of the rotor 2. The rotor 2 can have, in particular, at least one coolant channel 5 on each axial side of the coolant entry 9 thereby, which conveys the coolant, starting from the central region, or the coolant entry 9, toward the respective end surface of the rotor located at this side. Accordingly, these two coolant channels 5 cause a conveyance in opposing directions, specifically toward the respective end surface of the rotor located at the respective axial side. Alternatively, it may be provided that the coolant entry 9 is provided in the region of an axial end surface of the rotor 2, which lies opposite the respective end surface of the rotor from which the coolant exits from the coolant channel 5. Accordingly, the coolant channel 5 is then designed such that the coolant is conveyed at the opposing axial end surface of the rotor 2, and is thrown away from the rotor 2 there.

FIG. 2 shows an unrolled radial inner surface of a rotor 2 having a coolant channel 5 located thereon. This can be the coolant channel 5 from FIG. 1 thereby. The coolant channel 5 is illustrated symbolically as merely a line. In accordance with FIG. 2, the slope of the coolant channel 5 increases in the axial direction, starting from a coolant channel entry 9 toward a coolant exit 10, thus toward the respective winding head, or the end surface end of the coolant channel 5. The coolant entry 9 is provided thereby in the vicinity of a first axial end surface of the rotor 2 (on the right-hand side in FIG. 2), wherein the coolant exit 10 is provided on an opposing second end surface of the rotor 2. As a result, the coolant flows through approximately the entire axial length of the rotor 2, before it is thrown away from the rotor 2. The coolant entry 9 can be designed, for example, as an opening in the output shaft 6 of the electric machine 1, through which coolant can be or is conducted through the output shaft 6 to the rotor 2.

FIG. 3 shows a longitudinal section through an electric machine 1 in a vehicle drive train. The electric machine 1 serves as a traction drive for the vehicle therein. An electric machine 1 of this type, however, can also be used for any other suitable purpose, e.g. for driving a tool machine, an elevator, etc.

In accordance with FIG. 3, the electric machine 1 is accommodated in a housing 8, e.g. a transmission housing or a clutch housing. The stator 3 is disposed in a stationary manner on the housing 8. The stator 3 is composed of a laminated core, for example, in which electrical conductors running in the axial direction are placed, in the form of a winding. In the region of the axial end surfaces of the stators 3, the electrical conductors are bent and form so-called winding heads 4, 4′. The rotor 2 of the electric machine 1 is provided radially inside the stator 3. Accordingly, the electric machine 1 is an internal rotor machine. The rotor 2 rotatably drives an output shaft 6 of the electric machine 1. The stator 3 has a greater expansion in the axial direction than the rotor 2. Specifically, the stator extends with its winding heads 4, 4′ beyond the rotor 2 in the axial direction. There is therefore the danger that coolant from the rotor 2 may end up on the winding head 4, 4′, and from there in the air gap between the rotor 2 and the stator 3.

The rotor 2 has a pot-shaped inner part 11, on the outside of which a laminated core of the rotor 2 is attached radially. Depending on the design of the electric machine 1, the rotor 2 may also have, e.g. permanent magnets or a cage made of electrical conductors. A coolant channel 5 for a liquid cooling system of the rotor 2 is provided on a radial inner surface of the inner part 11. The coolant channel 11 runs in a helical path from a first axial half of the rotor 2 to an end surface of the rotor 2, wherein the coolant channel 5 opens into an inner space of the electric machine. In FIG. 3 this is the left-hand end surface of the rotor 2. The coolant channel 5 is designed, according to FIG. 3, as a groove opening radially toward the inside. It is however conceivable that the coolant channel is closed, at least in part. A slope of the coolant channel 5 increases toward its opening, thus toward the left-hand side of FIG. 3. As a result, the coolant that flows through the rotor 2 in the coolant channel 5 is accelerated toward the axial exit opening (coolant exit 10). In order to prevent coolant from the rotor 2 ending up in the air gap between the rotor 2 and the stator 3, the coolant channel 5 is designed such that coolant flowing through this coolant channel 5 is thrown axially beyond the respective winding heads 4, 4′. As a result, the bulk of the coolant flowing through the coolant channel 5 is thrown toward the left, beyond the winding head 4′.

As can be derived from FIG. 3, the inner part 11 of the rotor 2 may have an at least two-part design. The parts 11A, 11B of the inner part 11 are connected, in particular permanently, to one another; e.g. screwed together, glued, clamped, latched, etc. The second part 11B of the inner part 11, in particular, has a penetration for the coolant channel 5 (not visible in FIG. 3). The second part 11B may support a first bearing 7 thereby, which rotatably supports the rotor 2. The first part 11A can have the coolant channel 5, and optionally, may support a second bearing 7′, which likewise rotatably supports the rotor 2. The rotor 2 is supported radially inside the rotor 2 via the first bearing 7, and the rotor 2 is supported radially outside the rotor 2 via the second bearing 7′. The bearings 7, 7′ are designed, by way of example, as roller bearings, in this case as a groove-ball bearing and a needle bearing. The two bearings 7, 7′ can however be designed differently, e.g. as a sliding bearing. In FIG. 3, the first bearing 7 is designed as a fixed bearing, while the second bearing 7′ is designed as a floating bearing. The fixed and floating bearings could, however, be exchanged.

A transmission step 12 is provided radially inside the inner part 11, which converts a rotational rate of the rotor 2 into a different rotational rate of the output shaft 6. The transmission step 12 is designed as a planetary stage. The inner part 11 of the rotor 2 is connected in at least a non-rotatable manner to a ring gear 12A of the planetary stage 12. For this, the inner part 11 may have, in particular, an inner toothing, as shown, which meshes in a form fitting manner with a corresponding outer toothing of the ring gear 12A. The ring gear 12A is then secured axially by a side wall of the part 11A and a securing ring in the inner part 11, for example. As a matter of course, the ring gear 12A can also be attached to the inner part 11 in a different manner, e.g. it can be screwed onto it, or welded thereto. A sun gear 12B of the planetary stage 12 is non-rotatably connected to the housing 8. In contrast, a planet carrier 12C of the planetary state 12, on which planet gears 12D of the planetary stage 12 are rotatably disposed, is connected in a non-rotatable manner to the output shaft 6. In the manner known per se, the planet gears 12D mesh with both the ring gear 12A as well as the sun gear 12B, and orbit the sun gear 12B in the circumferential direction when the rotor 2 rotates. The planet carrier 12C moves therewith, and causes the output shaft 6 to rotate. As a result, a particularly compact transmission step is formed by the planetary stage, which converts a rotation to a slower rotation.

As is shown in FIG. 3, it may be provided that the first bearing 7 of the rotor 2 is rotatably supported on the planet carrier 12D, and thus on the output shaft 6. The second bearing 7′ is then designed such that it rotatably supports the rotor 2 on the housing 8 of the electric machine 1. At least one channel is provided inside the output shaft 6, through which the coolant used for cooling the rotor 2 is conducted. The channel can be designed such that the coolant is first conducted to the planetary gear stage 12, and then to the inner part 11 of the rotor 2, or that it arrives in parallel flows at both the inner part 11 as well as the planetary gear stage 12, wherein it is received or collected in the inner part 11 by the coolant channel 5, and is conveyed along the inner part 11 to the coolant exit 10. This is based on the fact that the planetary gear stage 12 is lubricated and the rotor 2 is cooled by means of the coolant. At least one coolant entry 9 of the coolant into the coolant channel 5 is located therefore in the region of the ring gear 12A, or the planet gear 12D. For this, the ring gear 12A may have corresponding openings, in particular, for the coolant. An exemplary course of a coolant flow, starting from the output shaft 6, is depicted in FIG. 3 with a broken line.

The electric machine 1 shown in FIG. 3 is distinguished by a very high power density, as well as a high level of efficiency, and a high output torque. This is achieved by the measures depicted in FIG. 3. This electric machine 1 is particularly compact, and is therefore suitable for use, preferably, in a motor vehicle drive train, as a traction drive, but it may also be used for other drive purposes, as explained above. It is clear that with the electric machine 1 shown in FIG. 3, the transmission step 12 can also be omitted. In this case, the inner part 11 can be at least non-rotatably, directly connected to the output shaft 6 via its first or second part 11A, 11B.

### REFERENCE SYMBOLS

1 Electric machine
2 Rotor
3 Stator
4, 4′ Winding head
5 Coolant channel
6 Output shaft
7, 7′ Bearing
8 Housing
9 Coolant entry
10 Coolant exit
11 Inner part
11A Part of the inner part 11
11B Part of the inner part 11
12 Planetary stage
12A Ring gear
12B Sun gear
12C Planet carrier
12D Planet gear
X rotational axis of the rotor 2

1. An electric machine comprising:
a stator and
a rotor,
wherein the stator has windings with at least one frontal winding head, and
wherein the rotor has a partially helical coolant channel which is open in the axial direction of the at least one frontal winding head such that coolant is conveyed from the coolant channel toward the at least one frontal winding head when the rotor rotates,
wherein the rotor and the coolant channel are designed such that the coolant is thrown axially out of the coolant channel beyond the at least one frontal winding head in an axial direction when the rotor rotates.

2. The electric machine according to claim 1, wherein a slope of the helical part of the coolant channel increases axially toward the at least one frontal winding head.

3. The electric machine according to claim 1, wherein the rotor has a pot-shaped inner part, wherein the coolant channel is disposed on the radial inner wall of the inner part, wherein the coolant channel is formed by a groove in the inner part, wherein the groove is open radially toward the inside of the inner part.

4. The electric machine according to claim 3, wherein the rotor has a laminated core which is disposed radially on the outside of the inner part.

5. The electric machine according to claim 3, wherein a transmission step is provided radially on the inside of the inner part, wherein the transmission step converts a rotational rate of the rotor into a different rotational rate of an output shaft of the electric machine.

6. The electric machine according to claim 5, wherein the transmission step is designed as a planetary stage, and the inner part is connected at least in a non-rotational manner to a ring gear of the planetary stage, and wherein the output shaft is connected to a planet carrier or a sun gear of the planetary stage, in at least a non-rotatable manner.

7. The electric machine according to claim 5, wherein the coolant also serves as a lubricant for the transmission step.

8. The electric machine according to claim 3, wherein the rotor is rotatably supported via the inner part and a bearing disposed radially inside the inner part.

9. The electric machine according to claim 3, wherein the rotor is rotatably supported via the inner part and a bearing disposed radially outside the inner part.

10. A motor vehicle drive train comprising:
an electric machine according to claim 1, wherein the electric machine is as a traction drive.

11. The electric machine according to claim 1, wherein a majority of the coolant is thrown beyond the at least one frontal winding head in an axial direction when the rotor rotates at the typical operational rotational rate of the electric machine.

12. The electric machine according to claim 1, wherein a depth of the coolant channel increases axially toward the at least one frontal winding head.

13. The electric machine according to claim 1, wherein the coolant channel is at least partially closed radially over its length.

14. The electric machine according to claim 1, wherein the rotor has a shorter axial length than the stator.

15. The electric machine according to claim 1, wherein the coolant channel comprises a coolant entry point disposed in an axially central region of the rotor.

16. The electric machine according to claim 15, wherein the coolant channel comprises a first coolant channel and a second coolant channel, wherein the first and second coolant channels are disposed on opposite sides of the coolant entry point, wherein the first coolant channel conveys coolant toward a first axial end of the rotor and the second coolant channel conveys coolant to a second axial end of the rotor that is opposite the first axial end of the rotor.

18. The electric machine according to claim 2, wherein the slope of the helical part of the coolant channel increases at an exponential rate.

19. The electric machine according to claim 6, wherein the coolant channel comprises a coolant entry point disposed in the region of the ring gear or the planet carrier.

20. The electric machine according to claim 3, wherein the rotor is rotatably supported via the inner part and a first bearing disposed radially inside the inner part and a second bearing disposed radially outside the inner part, wherein the first bearing is a fixed bearing and the second bearing is a floating bearing.
